(19) United States
(12) Patent Application Publication
(10) Pub. No.: US 2025/0110727 A1
(43) Pub. Date: Apr. 3, 2025

(54) UNINTERRUPTIBLE POWER SUPPLY FIRMWARE UPGRADE WITH ACCURATE PROGRESS INDICATION

(71) Applicant: SCHNEIDER ELECTRIC IT CORPORATION, Foxboro, MA (US)

(72) Inventor: Rana Das, Lowell, MA (US)

(21) Appl. No.: 18/891,412

(22) Filed: Sep. 20, 2024

(30) Foreign Application Priority Data
Sep. 28, 2023 (IN) 202311065322

(51) Int. Cl. G06F 8/65; G06F 11/32

(52) U.S. Cl. CPC G06F 8/65; G06F 11/32

(57) ABSTRACT

A non-transitory computer readable media having instructions encoded therein which, when executed by an uninterruptible power supply (UPS), cause the UPS to perform a method comprising receiving firmware to be installed on the UPS, transitioning a communication subsystem of the UPS to operation in a bootloader mode, determining, by the communication subsystem, a size of the firmware to be installed, initiating, by the communication subsystem, installation of the firmware in an application memory region of a processing subsystem of the UPS, determining, by the communication subsystem, an amount of the firmware installed in the application memory region, calculating, by the communication subsystem, a percent of the firmware installed in the application memory region based on the size of the firmware and the amount of the firmware installed in the application memory region, and outputting, by the communication subsystem, an indication of the percent of the firmware installed.

### CROSS-REFERENCE TO RELATED APPLICATIONS

This application claims priority under 35 U.S.C. § 119(e) to Indian Provisional Patent Application Ser. No. 20/231,1065322, titled UNINTERRUPTIBLE POWER SUPPLY FIRMWARE UPGRADE WITH ACCURATE PROGRESS INDICATION, filed Sep. 28, 2023, the entire content of which is incorporated herein by reference.

### BACKGROUND

### 1. Field of the Disclosure

At least one example in accordance with the present disclosure relates generally to uninterruptible power supplies and to methods of upgrading the firmware in same.

### 2. Discussion of Related Art

Power devices, such as uninterruptible power supplies, may be used to provide power to one or more loads. An uninterruptible power supply (UPS) typically includes a controller and a memory including firmware for instructing the UPS to perform its intended functions. The firmware may be upgradable to include new functionality or to correct an issue with operation of the UPS.

### SUMMARY

According to at least one aspect of the present disclosure, there is provided a non-transitory computer readable media having instructions encoded therein which, when executed by an uninterruptible power supply (UPS), cause the UPS to perform a method comprising receiving firmware to be installed on the UPS, transitioning a communication subsystem of the UPS from operation in a normal operation mode to operation in a bootloader mode, determining, by the communication subsystem of the UPS, a size of the firmware to be installed, initiating, by the communication subsystem of the UPS, installation of the firmware in an application memory region of a processing subsystem of the UPS, determining, by the communication subsystem of the UPS, an amount of the firmware installed in the application memory region of the processing subsystem, calculating, by the communication subsystem of the UPS, a percent of the firmware installed in the application memory region of the processing subsystem based on the size of the firmware and the amount of the firmware installed in the application memory region of the processing subsystem, and outputting, by the communication subsystem of the UPS, an indication of the percent of the firmware installed.

In some embodiments, the instructions cause UPS to obtain the firmware from an external device.

In some embodiments, outputting the indication of the percent of the firmware installed by the communication subsystem of the UPS includes outputting, by the communication subsystem of the UPS to an external device, a heartbeat signal providing an indication that the UPS is connected to the external device, the heartbeat signal including the indication of the percent of the firmware installed.

In some embodiments, the firmware includes a header having an indication of the size of the firmware, and the instructions further cause the communication subsystem of the UPS to determine the size of the firmware to be installed by reading the header of the firmware.

In some embodiments, determining, by the communication subsystem of the UPS, the amount of the firmware installed in the application memory region of the processing subsystem, includes the processing subsystem providing a signal regarding the amount of firmware installed to the communication subsystem.

In some embodiments, the instructions further cause the UPS to output data associated with a visual indication of the percent of the firmware installed based on the indication of the percent of the firmware installed.

In some embodiments, outputting the data associated with the visual indication of the percent of the firmware installed causes the visual indication to be displayed on a display of an external device in communication with the UPS.

In some embodiments, outputting the data associated with the visual indication of the percent of the firmware installed causes the visual indication to be displayed on a display of the UPS.

In some embodiments, the instructions further cause the UPS to output data associated with a status bar indicating the percent of the firmware installed based on the indication of the percent of the firmware installed.

In some embodiments, the instructions further cause the UPS to output data associated with a numerical indication of the percent of the firmware installed based on the indication of the percent of the firmware installed.

In some embodiments, the instructions further cause the UPS to continue installation of the firmware and output updates to the indication of the percent of the firmware installed until an entire amount of the firmware is installed.

In some embodiments, the instructions further cause the UPS to continue installation of the firmware and to update a visual indication of the percent of the firmware installed until an entire amount of the firmware is installed.

In some embodiments, the instructions further cause the communication subsystem of the UPS to output a completion signal indicating that the firmware upgrade has completed responsive to an entire amount of the firmware having been installed.

In some embodiments, the instructions further cause the UPS to cause an external device in communication with the UPS to display an indication of completion of the firmware upgrade responsive to receipt of a completion signal indicating that the firmware upgrade has completed.

In some embodiments, the instructions further cause the UPS to transition the communication subsystem back from operation in the bootloader mode to operation in the normal operation mode responsive to an entire amount of the firmware having been installed.

In some embodiments, the instructions further cause the UPS to encode the indication of the percent of the firmware installed within a heartbeat signal that is sent by the communication subsystem to an external device and that provides an indication that the UPS is connected to the external device.

According to another aspect of the present disclosure, there is provided a method of performing a firmware upgrade on an uninterruptible power supply (UPS). The method comprises receiving firmware to be installed on the UPS, transitioning a communication subsystem of the UPS from operation in a normal operation mode to operation in a bootloader mode, determining, by the communication subsystem of the UPS, a size of the firmware to be installed, initiating installation of the firmware in an application memory region of a processing subsystem of the UPS by the communication subsystem, determining, by the communication subsystem of the UPS, an amount of the firmware installed in the application memory region of the processing subsystem, calculating, by the communication subsystem of the UPS, a percent of the firmware installed in the application memory region of the processing subsystem based on the size of the firmware and the amount of the firmware installed in the application memory region of the processing subsystem, and outputting, by the communication subsystem of the UPS, an indication of the percent of the firmware installed.

In some embodiments, the firmware to be installed on the UPS is received from an external device.

In some embodiments, outputting the indication of the percent of the firmware installed by the communication subsystem of the UPS, includes outputting, by the communication subsystem of the UPS to an external device, a heartbeat signal providing an indication that the UPS is connected to the external device, the heartbeat signal including the indication of the percent of the firmware installed.

In some embodiments, the firmware includes a header having an indication of the size of the firmware and determining, by the communication subsystem of the UPS, the size of the firmware to be installed includes the communication subsystem of the UPS reading the header of the firmware.

In some embodiments, determining, by the communication subsystem of the UPS, the amount of the firmware installed in the application memory region of the processing subsystem, includes the processing subsystem providing a signal regarding the amount of firmware installed to the communication subsystem.

In some embodiments, the method further comprises outputting data associated with a visual indication of the percent of the firmware installed based on the indication of the percent of the firmware installed.

In some embodiments, outputting the data associated with the visual indication of the percent of the firmware installed causes the visual indication to be displayed on a display of an external device in communication with the UPS.

In some embodiments, outputting the data associated with the visual indication of the percent of the firmware installed causes the visual indication to be displayed on a display of the UPS.

In some embodiments, the method further comprises outputting data associated with a status bar indicating the percent of the firmware installed based on the indication of the percent of the firmware installed.

In some embodiments, the method further comprises outputting data associated with a numerical indication of the percent of the firmware installed based on the indication of the percent of the firmware installed.

In some embodiments, the method further comprises continuing installation of the firmware and outputting updates to the indication of the percent of the firmware installed until an entire amount of the firmware is installed.

In some embodiments, the method further comprises continuing installation of the firmware and updating a visual indication of the percent of the firmware installed until an entire amount of the firmware is installed.

In some embodiments, the method further comprises outputting, by the communication subsystem of the UPS, a completion signal indicating that the firmware upgrade has completed responsive to an entire amount of the firmware having been installed.

In some embodiments, the method further comprises displaying an indication of completion of the firmware upgrade responsive to receipt of a completion signal indicating that the firmware upgrade has completed.

In some embodiments, the method further comprises transitioning the communication subsystem back from operation in the bootloader mode to operation in the normal operation mode responsive to an entire amount of the firmware having been installed.

In some embodiments, the method further comprises encoding the indication of the percent of the firmware installed within a heartbeat signal that is sent by the communication subsystem to an external device and that provides an indication that the UPS is connected to the external device.

In accordance with another aspect of the present disclosure, there is provided a non-transitory computer readable media having instructions encoded therein which, when executed by an uninterruptible power supply, cause the uninterruptible power supply to perform one or more of the embodiments of the method described above.

In accordance with another aspect, there is provided an uninterruptible power supply (UPS) including a control system including a communication subsystem and a processing subsystem configured to perform a method comprising receiving firmware to be installed on the UPS from an external device, transitioning the communication subsystem of the UPS from operation in a normal operation mode to operation in a bootloader mode, determining, by the communication subsystem, a size of the firmware to be installed, initiating installation of the firmware in an application memory region of the processing subsystem by the communication subsystem, determining, by the communication subsystem, an amount of the firmware installed in the application memory region of the processing subsystem, calculating, by the communication subsystem, a percent of the firmware installed in the application memory region of the processing subsystem based on the size of the firmware and the amount of the firmware installed in the application memory region of the processing subsystem, and outputting, by the communication subsystem of the UPS, an indication of the percent of the firmware installed.

In some embodiments, the control system is further configured to output a heartbeat signal including an indication of the percent of the firmware installed to the external device which causes the external device to display a visual indication of the percent of the firmware installed based on the indication of the percent of the firmware installed included in the heartbeat signal.

In some embodiments, the control system is further configured to cause a visual indication of the percent of the firmware installed to be displayed on a display of the UPS based on the indication of the percent of the firmware installed.

In some embodiments, the control system is further configured to provide a status bar indicating the percent of the firmware installed based on the indication of the percent of the firmware installed.

In some embodiments, the control system is further configured to provide a numerical indication of the percent of the firmware installed based on the indication of the percent of the firmware installed.

In some embodiments, the control system is further configured to continue installation of the firmware and output updates to the indication of the percent of the firmware installed until an entire amount of the firmware is installed.

In some embodiments, the control system is further configured to continue installation of the firmware and update a display of a visual indication of the percent of the firmware installed until an entire amount of the firmware is installed.

In some embodiments, the control system is further configured to output a completion signal indicating that the firmware upgrade has completed responsive to an entire amount of the firmware having been installed.

In some embodiments, the control system is further configured to display an indication of completion of the firmware upgrade responsive to completion of the firmware upgrade.

In some embodiments, the control system is further configured to output a completion signal indicating that the firmware upgrade has completed and to cause the external device to display an indication of completion of the firmware upgrade responsive to an entire amount of the firmware having been installed.

In some embodiments, the control system is further configured to transition the communication subsystem back from operation in the bootloader mode to operation in the normal operation mode responsive to an entire amount of the firmware having been installed.

In some embodiments, the control system is further configured to encode the indication of the percent of the firmware installed within a heartbeat signal that provides an indication to an external device that the external device is in communication with the UPS.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of an uninterruptible power supply according to an example;

FIG. 2 schematically illustrates controller and memory subsystems of an uninterruptible power supply according to an example;

FIG. 3 is a flowchart of an example of a method of performing a firmware update on an uninterruptible power supply; and

FIG. 4 schematically illustrates communications between subsystems of a controller of an uninterruptible power supply according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

An uninterruptible power supply (UPS) may be used to provide continuity of power to loads which are normally powered by, for example, utility AC mains power, and which a user finds downtime due to issues with the AC mains power supply undesirable or unacceptable. A UPS typically includes one or more sensors to monitor the quality of the mains power supply to a load and functionality to switch the supply of power to a backup power source if the quality of the mains power supply drops below an acceptable level. UPSs may be used as backup power supplies to multiple kinds of loads. Example of loads that commonly are provided with a UPS for continuity of power are computer servers. A data center may include racks for holding one or more computer servers as well as one or more UPSs to provide backup power to the one or more computer servers.

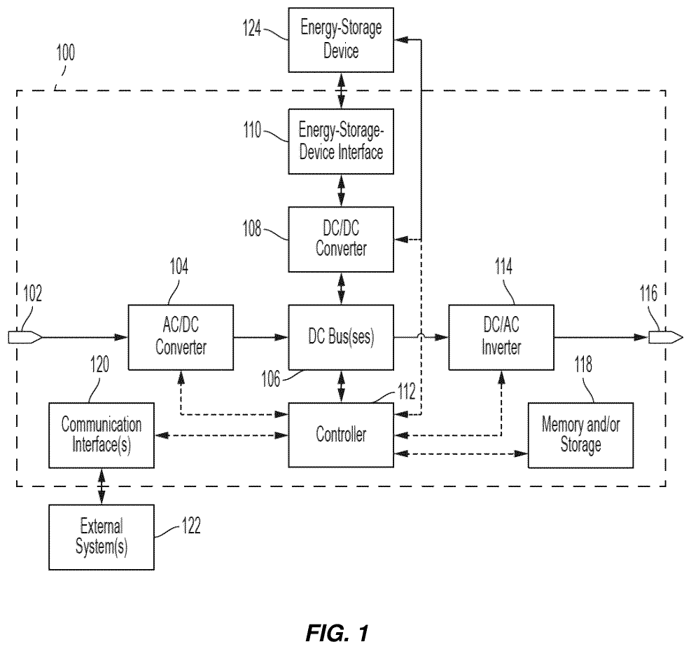

FIG. 1 is a block diagram of a UPS 100 according to an example. In another example, FIG. 1 may illustrate a block diagram of one of several power modules of a UPS. The UPS 100 includes an input 102, an AC/DC converter 104, one or more DC busses 106, a DC/DC converter 108, an energy-storage-device interface 110, at least one controller 112, a DC/AC inverter 114, an output 116, a memory and/or storage 118, and one or more communication interfaces 120, which may be communicatively coupled to one or more external systems 122.

The input 102 is coupled to the AC/DC converter 104 and to an AC power source (not pictured), such as an AC mains power supply. The AC/DC converter 104 is coupled to the input 102 and to the one or more DC busses 106, and is communicatively coupled to the controller 112. The one or more DC busses 106 are coupled to the AC/DC converter 104, the DC/DC converter 108, and to the DC/AC inverter 114, and are communicatively coupled to the controller 112. The DC/DC converter 108 is coupled to the one or more DC busses 106 and to the energy-storage-device interface 110, and is communicatively coupled to the controller 112. The energy-storage-device interface 110 is coupled to the DC/DC converter 108, and is configured to be coupled to at least one energy-storage device 124 and/or another energy-storage device.

In some examples, the energy-storage device 124 is external to the UPS 100 and coupled to the UPS 100 via the energy-storage-device interface 110. In various examples, the UPS 100 may include one or more energy-storage devices, which may include the energy-storage device 124. The energy-storage device 124 may include one or more batteries, capacitors, flywheels, or other energy-storage devices.

The DC/AC inverter 114 is coupled to the one or more DC busses 106 and to the output 116, and is communicatively coupled to the controller 112. The output 116 is coupled to the DC/AC inverter 114, and to an external load (not pictured). The controller 112 is communicatively coupled to the AC/DC converter 104, the one or more DC busses 106, the DC/DC converter 108, the energy-storage-device interface 110, the DC/AC inverter 114, the memory and/or storage 118, and the communication interfaces 120.

The input 102 is configured to be coupled to an AC mains power source and to receive input AC power having an input voltage level. The UPS 100 is configured to operate in different modes of operation based on the input voltage of the AC power provided to the input 102. The controller 112 may determine a mode of operation in which to operate the UPS 100 based on whether the input voltage of the AC power is acceptable. The controller 112 may include or be coupled to one or more sensors configured to sense parameters of the input voltage. For example, the controller 112 may include or be coupled to one or more sensors configured to sense a voltage level of the AC power received at the input 102.

When AC power provided to the input 102 is acceptable (for example, by having parameters, such as an input voltage value, that meet specified values, such as by falling within a range of acceptable input voltage values), the controller 112 controls components of the UPS 100 to operate in a normal mode of operation. In the normal mode of operation, AC power received at the input 102 is provided to the AC/DC converter 104. The AC/DC converter 104 converts the AC power into DC power and provides the DC power to the one or more DC busses 106. The one or more DC busses 106 distribute the DC power to the DC/DC converter 108 and to the DC/AC inverter 114. The DC/DC converter 108 converts the received DC power and provides the converted DC power to the energy-storage-device interface 110. The energy-storage-device interface 110 receives the converted DC power, and provides the converted DC power to the energy-storage device 124 to charge the energy-storage device 124. The DC/AC inverter 114 receives DC power from the one or more DC busses 106, converts the DC power into regulated AC power, and provides the regulated AC power to the output 116 to be delivered to a load.

When AC power provided to the input 102 from the AC mains power source is not acceptable (for example, by having parameters, such as an input voltage value, that do not meet specified values, such as by falling outside of a range of acceptable input voltage values), the controller 112 controls components of the UPS 100 to operate in a backup mode of operation. In the backup mode of operation, DC power is discharged from the energy-storage device 124 to the energy-storage-device interface 110, and the energy-storage-device interface 110 provides the discharged DC power to the DC/DC converter 108. The DC/DC converter 108 converts the received DC power and distributes the DC power amongst the one or more DC busses 106. For example, the DC/DC converter 108 may evenly distribute the power amongst the one or more DC busses 106. The one or more DC busses 106 provide the received power to the DC/AC inverter 114. The DC/AC inverter 114 receives the DC power from the one or more DC busses 106, converts the DC power into regulated AC power, and provides the regulated AC power to the output 116.

The controller 112 may store information in, and/or retrieve information from, the memory and/or storage 118. For example, the controller 112 may store information indicative of sensed parameters (for example, input-voltage values of the AC power received at the input 102) in the memory and/or storage 118. The controller 112 may further receive information from, or provide information to, the communication interfaces 120. The communication interfaces 120 may include one or more communication interfaces including, for example, user interfaces (such as display screens, touch-sensitive screens, keyboards, mice, track pads, dials, buttons, switches, sliders, light-emitting components such as light-emitting diodes, sound-emitting components such as speakers, buzzers, and so forth configured to output sound inside and/or outside of a frequency range audible to humans, and so forth), wired communication interfaces (such as wired ports), wireless communication interfaces (such as antennas), and so forth, configured to exchange information with one or more systems, such as the external systems 122, or other entities, such as human beings. The external systems 122 may include any device, component, module, and so forth, that is external to the UPS 100, such as a server, database, laptop computer, desktop computer, tablet computer, smartphone, central controller or data-aggregation system, other UPSs, and so forth.

Although illustrated as separate components, it is to be appreciated that in some embodiments, the controller 112 and the memory and/or storage 118 may be integrated together in a single component.

Examples of a UPS as disclosed herein may include various controllers, such as the controller 112, that may execute various operations discussed herein. Using data stored in associated memory and/or storage 118, the controller 112 may execute one or more instructions stored on one or more non-transitory computer-readable media, that may be included in or that may be the memory and/or storage 118, which the controller 112 may include and/or be coupled to, that may result in manipulated data. The memory and/or storage 118 may be or may include any one or more of a hard drive, SRAM, flash memory, or any other form of memory or data storage known in the art. In some examples, the controller 112 may include one or more processors or other types of controllers. In one example, the controller 112 is or includes at least one processor, for example, one or more digital signal processors, one or more microcontrollers, one or more system on a chip (SOC) device, or one or more general-purpose computer processors such as a Core® processor from Intel. In another example, the controller 112 performs at least a portion of the operations discussed above using one or more application-specific integrated circuits tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

In some examples, the UPS 100 may be a multi-phase UPS, such as a three-phase UPS. For example, the input 102 may include multiple inputs each configured to receive a respective phase line (and, in some examples, the multiple inputs may include a return input). Accordingly, although examples of FIG. 1 may be described with respect to a single connection and/or single-phase operation, it is to be appreciated that multi-phase operation is within the scope of FIG. 1 and the disclosure as a whole.

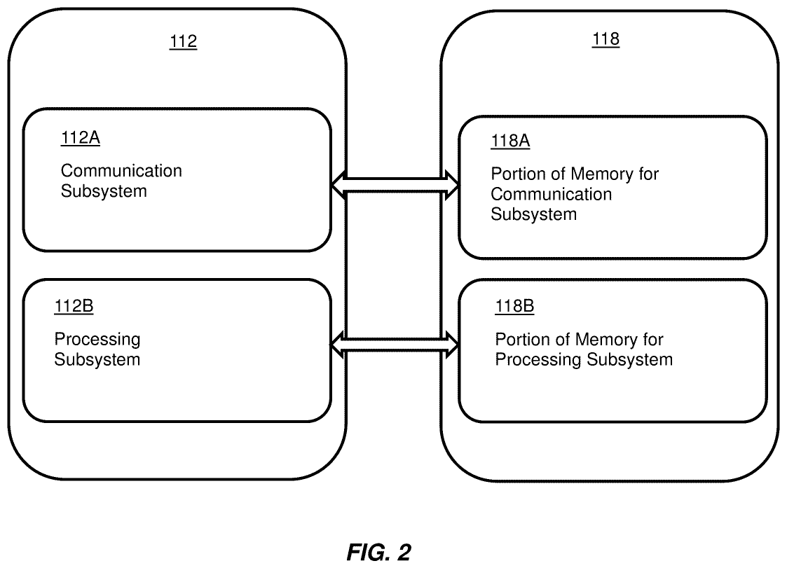

In some embodiments, the controller 112 may include multiple subsystems which may be implemented on separate processors, separate portions of a single processor or set of processors, or on a single processor or set of processors but at least partially logically separated in the sense that the different subsystems perform at least partially different functions. As illustrated schematically in FIG. 2, the subsystems of the controller may include a communication subsystem 112A and a processing subsystem 112B. The communication subsystem 112A manages communications between the UPS controller 112 and other components internal or external to the UPS, for example, through the communication interfaces 120 and performs functions associated with upgrading firmware of the UPS as explained in further detail below. The processing subsystem 112B executes commands as defined by the firmware installed on the UPS to cause the UPS to perform its intended functions, for example, monitoring of the mains AC power and switching to backup power as needed, controlling charging of the energy-storage device 124, performing system diagnostics, etc. The communication subsystem 112A and the processing system 112B may each be in communication with the memory and/or storage 118. In some embodiments, the communication subsystem 112A and the processing system 112B may each be in communication with different portions 118A, 118B of the memory and/or storage 118. The different portions 118A, 118B of the memory and/or storage 118 may be at least partially physically separated, at least partially logically separated, or both. In other embodiments, the memory and/or storage 118 is not separated into different portions separately associated with the communication subsystem 112A and the processing system 112B.

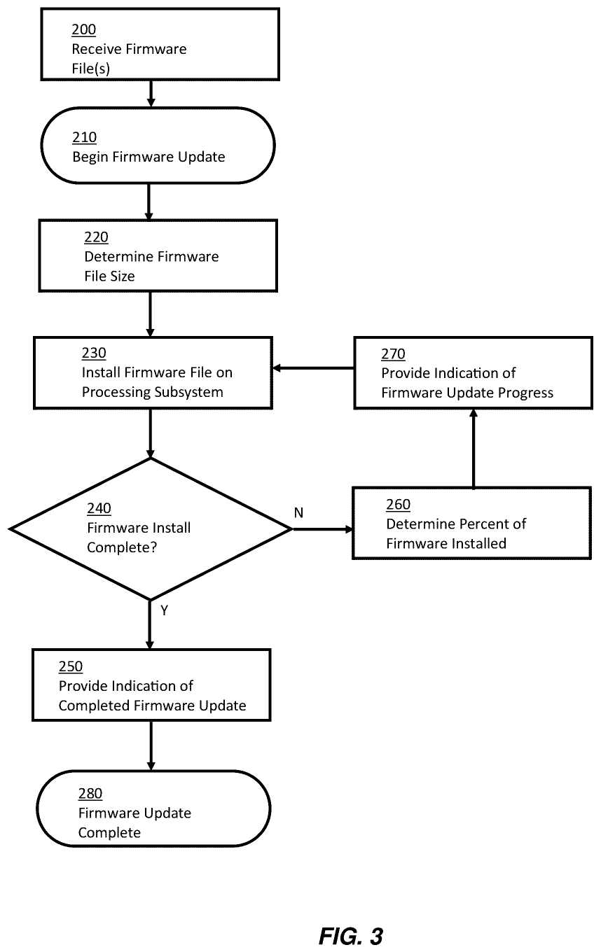

One example of a method of performing a firmware upgrade on a UPS is illustrated in the flowchart of FIG. 3. In a first act 200, the UPS receives a copy of firmware to be installed. The firmware may include one or more files. The UPS may receive the firmware from an external system or device 122 through the communication interface(s) 120. The external system or device 122 may be any device capable of storing and transferring the firmware to the UPS, for example, a laptop computer, a flash drive, a smartphone, etc. The firmware is first transferred to the communication subsystem 112A of the UPS controller 112. The communication subsystem 112A may store the firmware in the portion of the UPS memory 118A associated with the communication subsystem 112A. After the firmware is received by the UPS controller 112 the firmware upgrade may begin (act 210). In some embodiments, the firmware upgrade begins automatically during or after receipt of the firmware file(s). In other embodiments, the complete firmware file(s) are received by the UPS controller and the upgrade is then initiated by an operator.

To begin the firmware upgrade the communication subsystem 112A transitions from operating in a normal operations mode in which the UPS is performing the functions of monitoring the mains power supply and switching to backup power supply if needed to operation in a bootloader mode. The communication subsystem 112A determines a total size, in bytes, of the firmware to be installed (act 220). In some embodiments, the firmware file(s) that are provided to the UPS from the external system or device 122 include a header including an indication of the total size of the firmware to be installed. For example, a portion of the firmware header may have a number of bytes encoding the numerical size (e.g., the total number of bytes) of the firmware to be installed. The communication subsystem 112A may read the firmware size from the firmware header. Alternatively, the communication subsystem 112A may monitor the amount of data transferred into the UPS from the external system or device 122 while receiving the firmware file(s) to determine a total size (e.g., the total number of bytes) of the firmware to be installed. The communication subsystem 112A may record the total size of the firmware to be installed in the portion of the UPS memory 118A associated with the communication subsystem 112A.

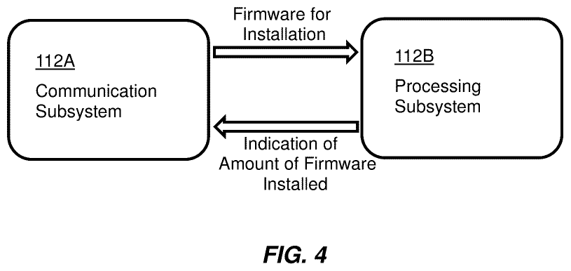

The communication subsystem 112A proceeds to initiate installation of the firmware in an application memory region within the portion of memory 118B of the processing subsystem 112B of the UPS (act 230). As the communication subsystem 112A installs the firmware the processing subsystem 112B sends a signal including an indication of the amount of firmware that has been installed back to the communication subsystem 112A (see FIG. 4) so that the communication subsystem may determine the amount of the firmware that has been installed in the application memory region of the processing subsystem 112B. The processing subsystem 112B may send this signal on a continuous basis or periodically, for example, each time a certain number of additional bytes of the firmware has been installed in the application memory region of the processing sub-system 112B or each time a certain amount of time has elapsed, for example, once per second.

While the firmware install is proceeding and has not yet completed (“N” branch of decision act 240), the communication subsystem 112A calculates a percent of the total firmware installed in the application memory region of the processing subsystem 112B based on the previously determined total size of the firmware and the amount of the firmware installed in the application memory region of the processing subsystem 112B as reported to the communication subsystem 112A by the processing subsystem 112B. The communication subsystem 112A outputs an indication of the percent of the firmware installed in the application memory region of the processing subsystem 112B (act 270). The indication of the percent of the firmware installed in the application memory region of the processing subsystem 112B may be output by the communication subsystem 112A as a signal sent to a user interface of the UPS included in the communication interface(s) 120 and/or to an external system or device 122 which may be the same external system or device that provided the firmware to the UPS or a different external system or device. The communication subsystem 112A may send this signal on a continuous basis or periodically, for example, each time the processing subsystem 112B sends a signal regarding the amount of the firmware has been installed in the application memory region of the processing subsystem 112B or each time a certain amount of time has elapsed, for example, once per second, to output updates to the indication of the percent of the firmware installed until an entire amount of the firmware is installed. If the indication of the percent of the firmware installed in the application memory region of the processing subsystem 112B is sent to an external system or device 122, it may be included in a heartbeat signal that is used to indicate to the external system or device 122 that it is connected to and in communication with the UPS. The communication subsystem 112A may encode the indication of the percent of the firmware installed in the application memory region of the processing subsystem 112B in the heartbeat signal before outputting the heartbeat signal. The signal including the indication of the percent of the firmware installed in the application memory region of the processing subsystem 112B may include data associated with a visual indication of the percent of the firmware installed, for example, data associated with a status bar indicating the percent of the firmware installed and/or data associated with a numerical indication of the percent of the firmware installed. The data associated with a visual indication of the percent of the firmware installed may include data used by a processor of the user interface of the UPS or the external system or device 122 to generate and output a signal to a display for displaying the visual indication. The user interface of the UPS and/or the external system or device 122 may provide the visual indication of the percent of the firmware installed in the application memory region of the processing subsystem 112B, for example, as a status bar and/or a numerical value in a display of the user interface of the UPS and/or the external system or device 122.

The method continues until the total amount of the firmware has been installed in the application memory region of the processing subsystem 112B, for example, until the communication subsystem determines that 100% of the firmware has been installed in act 260. If the total amount of the firmware has been installed, the method proceeds along the “Y” branch of decision act 240 and the communication subsystem 112A provides an indication of the firmware install having completed (act 250). The communication subsystem 112A may provide this indication as a completion signal indicating that the firmware upgrade has completed responsive to an entire amount of the firmware having been installed. The completion signal may be sent to the user interface of the UPS or an external system or device 122 which may provide a visual indication of completion of the firmware install in a display responsive to receiving the completion signal. If the indication of the firmware install having completed is sent by the communication system 112A to an external system or device 122 it may be included in a heartbeat signal sent to the external system or device 122. The communication subsystem 112A may encode the indication of the firmware install having completed in the heartbeat signal before outputting the heartbeat signal.

After completion of the installation of the firmware in the application memory region of the processing subsystem 112B the communication subsystem 112A transitions back from operation in the bootloader mode of operation to its normal mode of operation. The method then ends at act 280.

It is to be appreciated that this disclosure also contemplates a UPS, for example, a UPS 100 as illustrated in FIG. 1 with a controller 112 configured to perform embodiments of the method described above as well as a non-transitory computer readable media having instructions encoded therein which, when executed by a UPS, cause the UPS to perform embodiments of the method described above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A non-transitory computer readable media having instructions encoded therein which, when executed by an uninterruptible power supply (UPS), cause the UPS to perform a method comprising:
receiving firmware to be installed on the UPS;
transitioning a communication subsystem of the UPS from operation in a normal operation mode to operation in a bootloader mode;
determining, by the communication subsystem of the UPS, a size of the firmware to be installed;
initiating, by the communication subsystem of the UPS, installation of the firmware in an application memory region of a processing subsystem of the UPS;
determining, by the communication subsystem of the UPS, an amount of the firmware installed in the application memory region of the processing subsystem;
calculating, by the communication subsystem of the UPS, a percent of the firmware installed in the application memory region of the processing subsystem based on the size of the firmware and the amount of the firmware installed in the application memory region of the processing subsystem; and
outputting, by the communication subsystem of the UPS, an indication of the percent of the firmware installed.

2. The non-transitory computer readable media of claim 1, wherein the instructions cause UPS to obtain the firmware from an external device.

3. The non-transitory computer readable media of claim 1, wherein outputting the indication of the percent of the firmware installed by the communication subsystem of the UPS includes outputting, by the communication subsystem of the UPS to an external device, a heartbeat signal providing an indication that the UPS is connected to the external device, the heartbeat signal including the indication of the percent of the firmware installed.

4. The non-transitory computer readable media of claim 1, wherein the firmware includes a header having an indication of the size of the firmware, and the instructions further cause the communication subsystem of the UPS to determine the size of the firmware to be installed by reading the header of the firmware.

5. The non-transitory computer readable media of claim 1, wherein determining, by the communication subsystem of the UPS, the amount of the firmware installed in the application memory region of the processing subsystem, includes the processing subsystem providing a signal regarding the amount of firmware installed to the communication subsystem.

6. The non-transitory computer readable media of claim 1, wherein the instructions further cause the UPS to output data associated with a visual indication of the percent of the firmware installed based on the indication of the percent of the firmware installed.

7. The non-transitory computer readable media of claim 6, wherein outputting the data associated with the visual indication of the percent of the firmware installed causes the visual indication to be displayed on a display of an external device in communication with the UPS.

8. The non-transitory computer readable media of claim 1, wherein the instructions further cause the UPS to output data associated with a status bar indicating the percent of the firmware installed based on the indication of the percent of the firmware installed.

9. The non-transitory computer readable media of claim 1, wherein the instructions further cause the UPS to output data associated with a numerical indication of the percent of the firmware installed based on the indication of the percent of the firmware installed.

10. The non-transitory computer readable media of claim 1, wherein the instructions further cause the UPS to continue installation of the firmware and output updates to the indication of the percent of the firmware installed until an entire amount of the firmware is installed.

11. The non-transitory computer readable media of claim 1, wherein the instructions further cause the UPS to continue installation of the firmware and to update a visual indication of the percent of the firmware installed until an entire amount of the firmware is installed.

12. The non-transitory computer readable media of claim 1, wherein the instructions further cause the communication subsystem of the UPS to output a completion signal indicating that the firmware upgrade has completed responsive to an entire amount of the firmware having been installed.

13. The non-transitory computer readable media of claim 1, wherein the instructions further cause the UPS to cause an external device in communication with the UPS to display an indication of completion of the firmware upgrade responsive to receipt of a completion signal indicating that the firmware upgrade has completed.

14. The non-transitory computer readable media of claim 1, wherein the instructions further cause the UPS to transition the communication subsystem back from operation in the bootloader mode to operation in the normal operation mode responsive to an entire amount of the firmware having been installed.

15. The non-transitory computer readable media of claim 1, wherein the instructions further cause the UPS to encode the indication of the percent of the firmware installed within a heartbeat signal that is sent by the communication subsystem to an external device and that provides an indication that the UPS is connected to the external device.

16. An uninterruptible power supply (UPS) including a control system including a communication subsystem and a processing subsystem configured to perform a method comprising:
receiving firmware to be installed on the UPS from an external device;
transitioning the communication subsystem of the UPS from operation in a normal operation mode to operation in a bootloader mode;
determining, by the communication subsystem, a size of the firmware to be installed;
initiating installation of the firmware in an application memory region of the processing subsystem by the communication subsystem;
determining, by the communication subsystem, an amount of the firmware installed in the application memory region of the processing subsystem;
calculating, by the communication subsystem, a percent of the firmware installed in the application memory region of the processing subsystem based on the size of the firmware and the amount of the firmware installed in the application memory region of the processing subsystem; and
outputting, by the communication subsystem, an indication of the percent of the firmware installed.

17. The UPS of claim 16, wherein the control system is further configured to output a heartbeat signal including an indication of the percent of the firmware installed to the external device which causes the external device to display a visual indication of the percent of the firmware installed based on the indication of the percent of the firmware installed included in the heartbeat signal.

18. The UPS of claim 16, wherein the control system is further configured to provide a status bar indicating the percent of the firmware installed based on the indication of the percent of the firmware installed.

19. The UPS of claim 16, wherein the control system is further configured to provide a numerical indication of the percent of the firmware installed based on the indication of the percent of the firmware installed.

20. The UPS of claim 16, wherein the control system is further configured to continue installation of the firmware and output updates to the indication of the percent of the firmware installed until an entire amount of the firmware is installed.

21. The UPS of claim 16, wherein the control system is further configured to continue installation of the firmware and update a display of a visual indication of the percent of the firmware installed until an entire amount of the firmware is installed.

22. The UPS of claim 16, wherein the control system is further configured to output a completion signal indicating that the firmware upgrade has completed and to cause the external device to display an indication of completion of the firmware upgrade responsive to an entire amount of the firmware having been installed.

23. The UPS of claim 16, wherein the control system is further configured to transition the communication subsystem back from operation in the bootloader mode to operation in the normal operation mode responsive to an entire amount of the firmware having been installed.

24. The UPS of claim 16, wherein the control system is further configured to encode the indication of the percent of the firmware installed within a heartbeat signal that provides an indication to an external device that the external device is in communication with the UPS.

25. A method of performing a firmware upgrade on an uninterruptible power supply (UPS), the method comprising:
receiving firmware to be installed on the UPS;
transitioning a communication subsystem of the UPS from operation in a normal operation mode to operation in a bootloader mode;
determining, by the communication subsystem of the UPS, a size of the firmware to be installed;
initiating, by the communication subsystem, installation of the firmware in an application memory region of a processing subsystem of the UPS;
determining, by the communication subsystem of the UPS, an amount of the firmware installed in the application memory region of the processing subsystem;
calculating, by the communication subsystem of the UPS, a percent of the firmware installed in the application memory region of the processing subsystem based on the size of the firmware and the amount of the firmware installed in the application memory region of the processing subsystem; and
outputting, by the communication subsystem of the UPS, an indication of the percent of the firmware installed.
